(19) United States
(12) Patent Application Publication
(10) Pub. No.: US 2025/0320020 A1
(43) Pub. Date: Oct. 16, 2025

(54) TRIPLE CHAMBER, SEAL END, TUCK TOP BOX

(71) Applicant: Revobox Dispensing Technologies, LLC, Torrance, CA (US)

(72) Inventor: David Hengami, Torrance, CA (US)

(73) Assignee: Revobox Dispensing Technologies, LLC, Torrance, CA (US)

(21) Appl. No.: 19/178,496

(22) Filed: Apr. 14, 2025

Related U.S. Application Data
(60) Provisional application No. 63/634,275, filed on Apr. 15, 2024.

(51) Int. Cl. B65D 5/48; B31B 50/26; B31B 100/00; B31B 120/30; B65D 5/02; B65D 5/72

(52) U.S. Cl. CPC B65D 5/48014; B31B 50/262; B65D 5/0227; B65D 5/723; B31B 2100/00; B31B 2120/302

(57) ABSTRACT

A blank for forming a three-chambered box, the blank comprising twelve longitudinally connected panels. The fourth panel has a second bottom major flap foldably coupled to a bottom edge of the fourth panel and at least one first top major flap foldably coupled to a top edge portion of the fourth panel, each first top major flap having at least one tab. The sixth panel has at least one dispensing flap removably coupled to a top edge of the sixth panel. The tenth panel has at least one opening in the tenth panel, wherein at least one loop is formed along a distal end of the tenth panel. A three-chambered box formed from the blank. A method of folding the same.

### CROSS-REFERENCE TO RELATED APPLICATIONS

This U.S. Non-Provisional application claims priority to U.S. Provisional Application No. 63/634,275, titled “Triple Chamber, Seal End, Tuck Top Box,” filed Apr. 15, 2024, the contents of which are incorporated by reference herein in their entirety.

### BACKGROUND

Many users consume snack foods, and a current problem faced by users is how to portion control, share, and dispense the snack foods from the packaging without touching the remaining food contents in the packaging. It can be hard to control the speed and amount of food being dispensed from boxes and bags with open tops.

Moreover, it can be difficult to re-seal the box and/or bag when the user is done snacking. Known box designs have perforated openings that are not re-closable, or cannot be opened and closed in repetition.

Additionally, users may wish to snack on more than one snack, but typical packaging only contains one type of snack food.

Accordingly, there is a need for an improved triple chamber, seal end, tuck top box.

### DRAWINGS

The present invention satisfies this need. In a first embodiment, the present invention is directed to a blank for forming a three-chambered box. the blank comprises twelve longitudinally connected panels.

The first panel has a first side, a second side, a first top minor flap foldably coupled to a top edge of the first panel, and a first bottom minor flap foldably coupled to a bottom edge of the first panel.

The second panel has a first side, wherein the first side of the second panel is foldably coupled to the second side of the first panel, a second side, a first bottom major flap foldably coupled to a bottom edge of the second panel, and a top edge of second panel comprising at least one crescent shaped portion.

The third panel has a first side, wherein the first side of the third panel is foldably coupled to the second side of the second panel, a second side, a second top minor flap foldably coupled to a top edge of the third panel, and a second bottom minor flap foldably coupled to a bottom edge of the third panel.

The fourth panel has a first side, wherein the first side of the fourth panel is foldably coupled to the second side of the third panel, a second side, a second bottom major flap foldably coupled to a bottom edge of the fourth panel, and at least one first top major flap foldably coupled to a top edge portion of the fourth panel, each first top major flap having at least one tab.

The fifth panel has a first side, wherein the first side of the fifth panel is foldably coupled to the second side of the fourth panel, and a second side.

The sixth panel has a first side, wherein the first side of the sixth panel is foldably coupled to the second side of the fifth panel, a second side, and, at least one dispensing flap removably coupled to a top edge of the sixth panel. Each dispensing flap has at least one opening therethrough and at least one dispensing flap tab.

The seventh panel has a first side, wherein the first side of the seventh panel is foldably coupled to the second side of the sixth panel, and a second side.

The eighth panel has a first side, wherein the first side of the eighth panel is foldably coupled to the second side of the seventh panel, and a second side.

The ninth panel has a first side, wherein the first side of the ninth panel is foldably coupled to the second side of the eighth panel, and a second side.

The tenth panel has a first side, wherein the first side of the tenth panel is foldably coupled to the second side of the ninth panel, a second side, and at least one opening in the tenth panel, wherein at least one loop is formed along a distal end of the tenth panel.

The eleventh panel has a first side, wherein the first side of the eleventh panel is foldably coupled to the second side of the tenth panel, and a second side.

The twelfth panel has a first side, wherein the first side of the twelfth panel is foldably coupled to the second side of the eleventh panel, and a second side.

Optionally, the blank is made from paperboard.

In a second embodiment, the present invention is directed to a three-chambered box formed from the blank.

In a third embodiment, the present invention is directed to a method of forming a three-chambered box. The method comprises the steps of: a) providing the blank; b) lifting and folding the seventh, eighth, ninth, tenth, eleventh and twelfth panels inwards, toward an interior surface of the sixth panel; c) coupling an interior surface of the tenth panel to the interior surface of the sixth panel; d) lifting and folding the sixth, seventh, eighth, ninth, tenth, eleventh and twelfth panels inwards until an exterior surface of the eighth panel is proximate an interior surface of the fourth panel; e) coupling an exterior surface of the twelfth panel to the interior surface of the fourth panel, and, coupling the exterior surface of the eighth panel to the interior surface of the fourth panel; f) lifting and folding the fourth, fifth, sixth, seventh, eighth, ninth, tenth, eleventh and twelfth panels inwards until an exterior surface of the seventh panel is proximate an interior surface of the third panel, and, an exterior surface of the sixth panel is proximate an interior surface of the second panel; g) coupling the exterior surface of the seventh panel to the interior surface of the third panel; h) folding and coupling an interior surface of the first panel to an exterior surface of the fifth panel; i) folding the first and second bottom, minor panels inwards; j) folding the first and second bottom, major panels inwards and coupling an interior surface of the first and second bottom, major panels to an exterior surface of the first and second bottom minor panels; k) folding the first and second top minor flaps and the loop inwards; l) folding the first major tabs inwards, overlapping the folded first and second top minor flaps and loop; and m) folding the second major tabs inwards and coupling an interior surface of the second major tabs to an exterior surface of the first major tabs.

### DRAWINGS

These and other features, aspects, and advantages of the present invention will become better understood with regard to the following description, appended claims, and accompanying drawings.

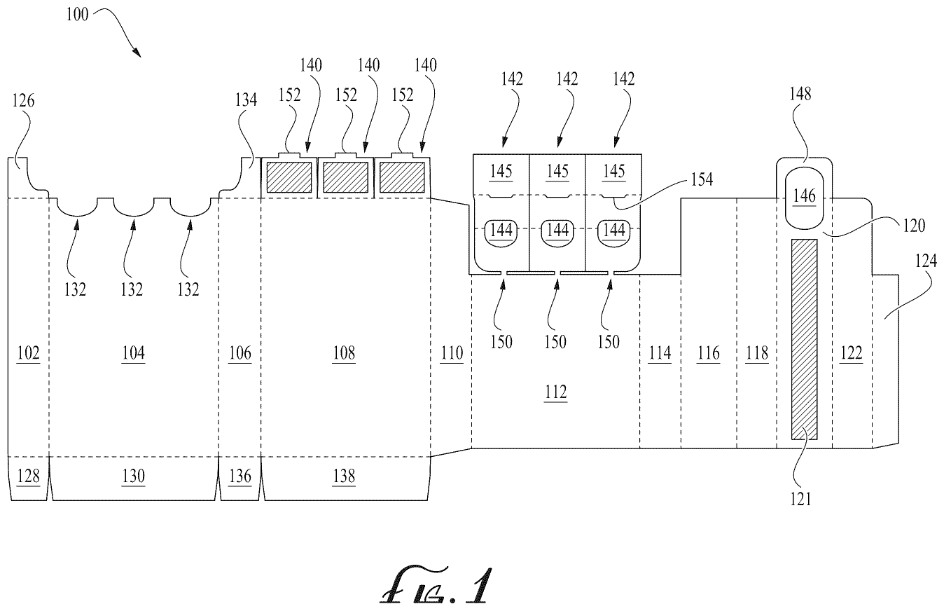

FIG. 1 is a top plan view of a blank used to form a triple-chamber, seal end, tuck top box having features of the present invention;

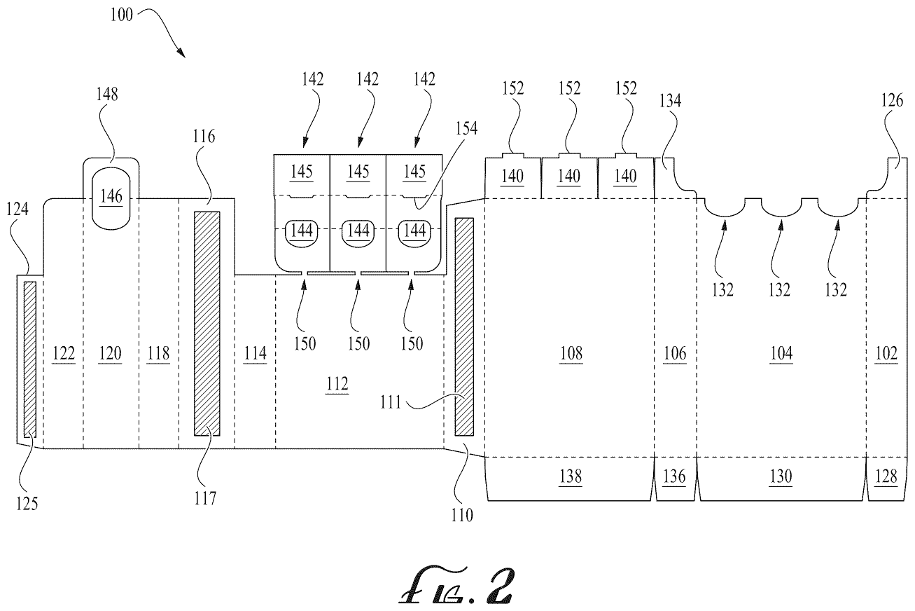

FIG. 2 is a bottom plan view of the blank of FIG. 1;

FIG. 3 is a bottom perspective view of a first step in folding the blank of FIG. 1;

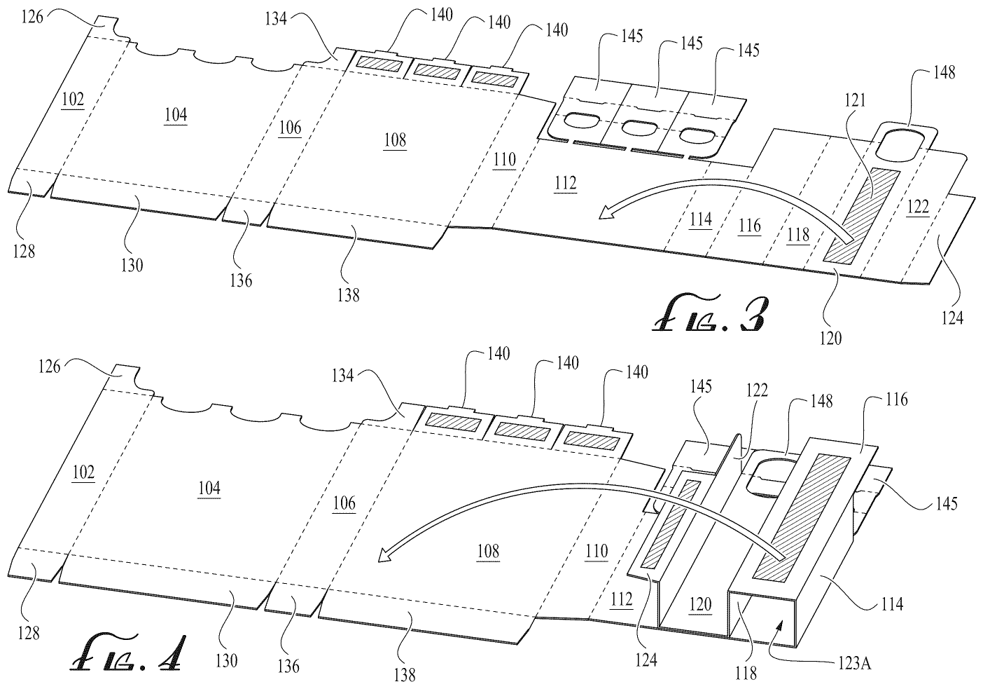

FIG. 4 is a bottom perspective view of a second step in folding the blank of FIG. 1;

FIG. 5 is a bottom, perspective, enlarged view of the folded portion of the blank of FIG. 4;

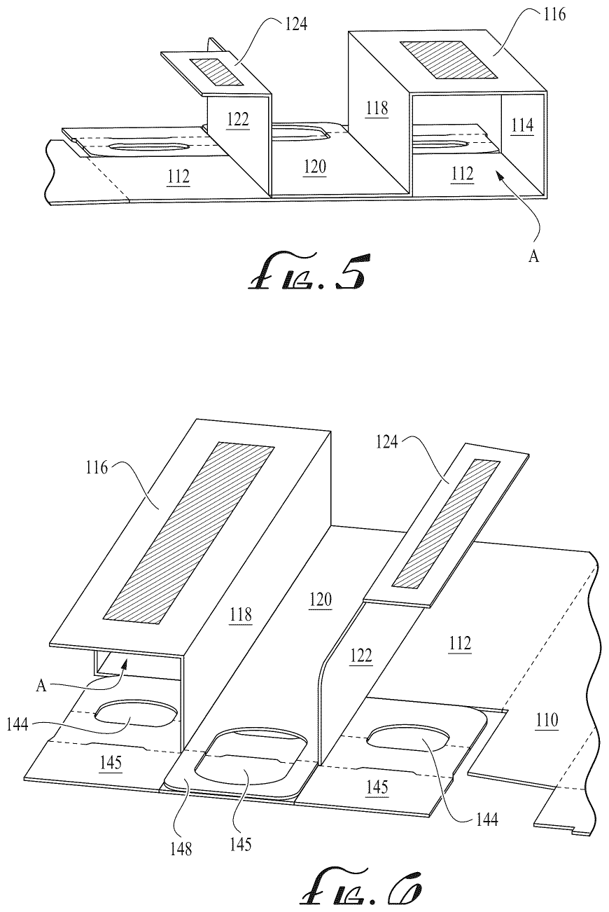

FIG. 6 is a top, perspective, enlarged view of the folded portion of the blank of FIG. 5;

FIG. 7 is a bottom perspective view of the partially folded blank of FIG. 5;

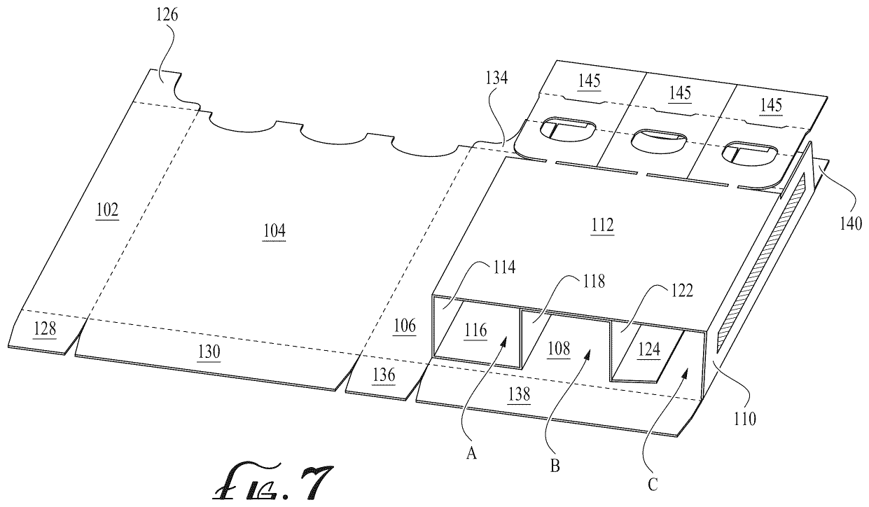

FIG. 8 is a top perspective view of the partially folded blank of FIG. 7, wherein a third step in folding the blank of FIG. 1 is shown;

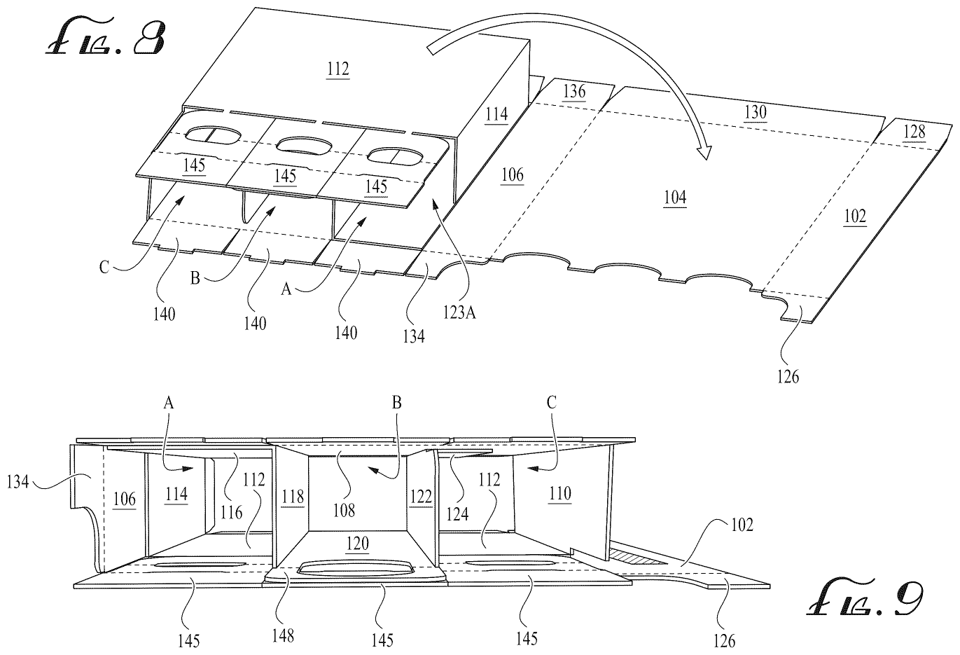

FIG. 9 is a top plan view of the partially folded blank of FIG. 8, after the third folding step has been completed;

FIG. 10 is a bottom perspective view of the partially folded blank of FIG. 9, wherein a fourth step in folding the blank of FIG. 1 is shown;

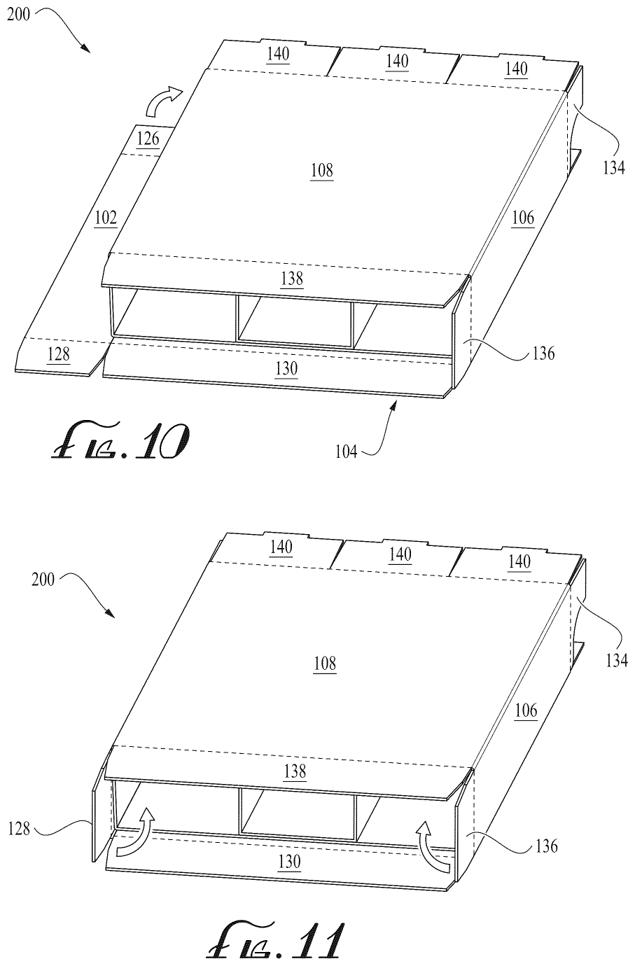

FIG. 11 is a bottom perspective view of the partially folded blank of FIG. 10, wherein a fifth step in folding the blank of FIG. 1 is shown;

FIG. 12 is a bottom perspective view of the partially folded blank of FIG. 11, wherein a sixth step in folding the blank of FIG. 1 is shown;

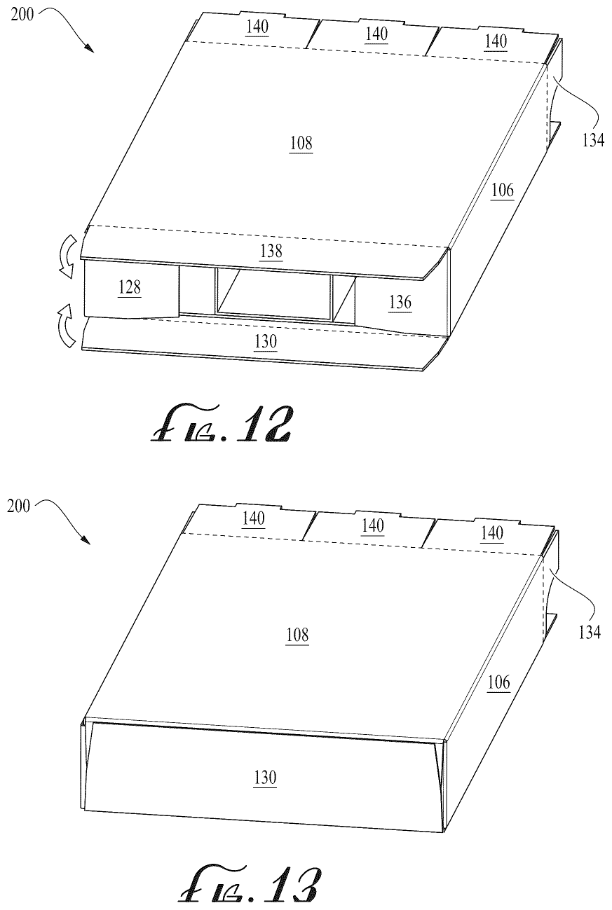

FIG. 13 is a bottom perspective view of the partially folded blank of FIG. 13, wherein the completed, closed bottom is shown;

FIG. 14 is a top plan view of the partially folded blank of FIG. 13;

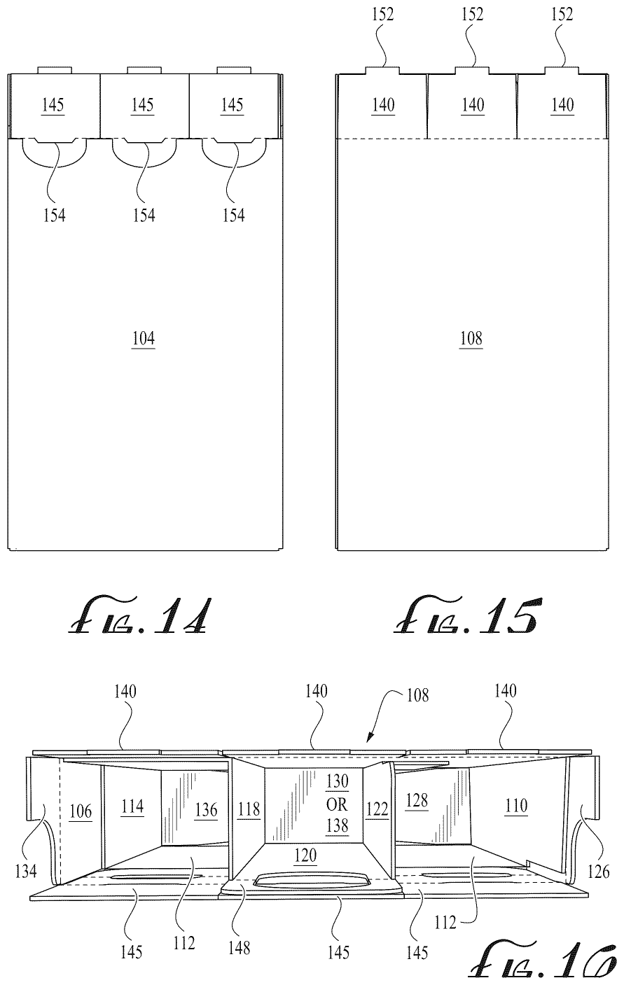

FIG. 15 is a bottom plan view of the partially folded blank of FIG. 14;

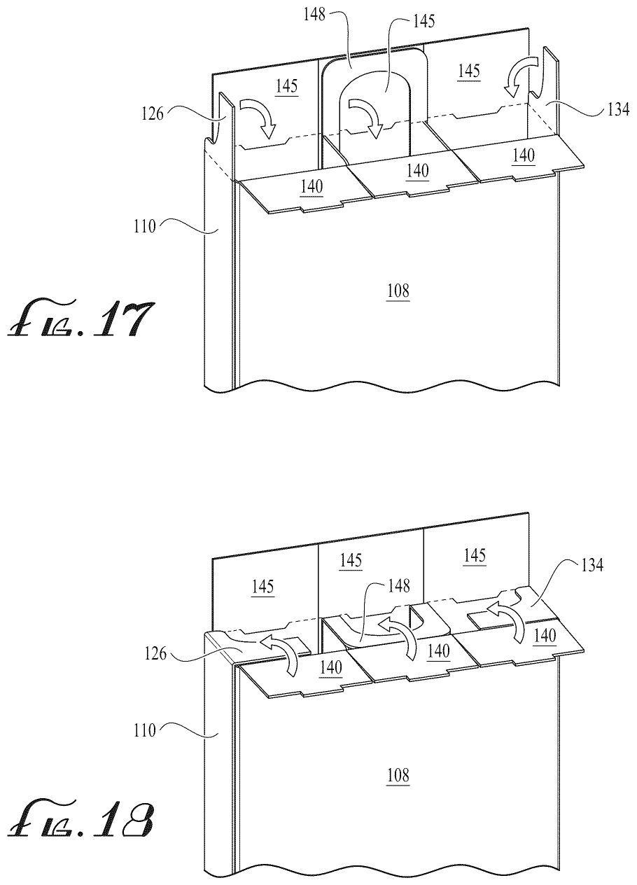

FIG. 16 is top plan view of the partially folded blank of FIG. 14, wherein the open top and the three internal chambers are shown;

FIG. 17 is a top perspective view of the top portion of the partially folded blank of FIG. 14, wherein a seventh step in folding the blank of FIG. 1 is shown;

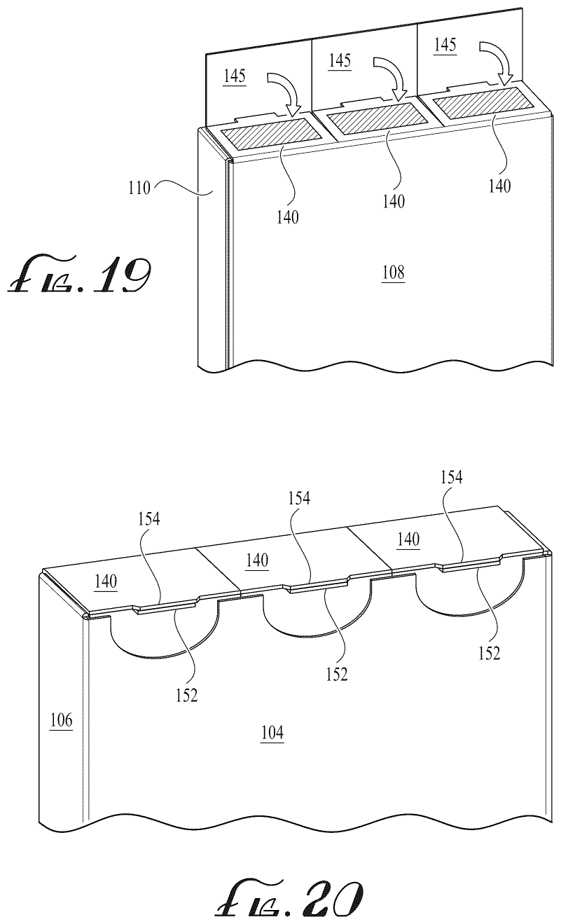

FIG. 18 is a top perspective view of the top portion of the partially folded blank of FIG. 17, wherein an eighth step in folding the blank of FIG. 1 is shown;

FIG. 19 is a top perspective view of the top portion of the partially folded blank of FIG. 18, wherein a ninth step in folding the blank of FIG. 1 is shown;

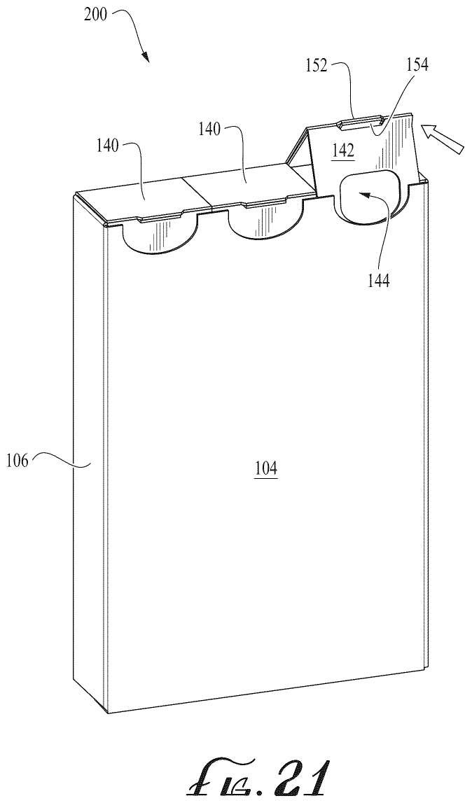

FIG. 20 is a top perspective view of the top portion of the partially folded blank of FIG. 19, wherein the completed ninth step in folding the blank of FIG. 1 is shown, creating the completed box; and

FIG. 21 is a front view of the box of FIG. 20, wherein a dispensing flap has been lifted open.

### DESCRIPTION

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers ingredients or steps.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a device disclosed in this disclosure will be determined by its intended use.

Referring now to FIGS. 1 and 2, there is shown a top plan view and a bottom plan view of a blank 100 used to form a triple chamber, seal end, tuck top box 200. In FIG. 1, an inside surface of the blank 100, and its foldably connected, longitudinal panels, are shown, and in FIG. 2, an outside surface of the blank 100 is shown.

The blank 100 comprises at least twelve, foldably connected panels: a first panel 102, a second panel 104, a third panel 106, a fourth panel 108, a fifth panel 110, a sixth panel 112, a seventh panel 114, an eighth panel 116, a ninth panel 118, a tenth panel 120, an eleventh panel 122, and a twelfth panel 124.

The first panel 102 is a side panel that is configured to form an exterior side of the box 200 when folded. The first panel 102 is foldably connected to one side of the second panel 104. The first panel 102 has a first top minor flap 126 and a first bottom minor flap 128 foldably coupled thereto.

The second panel 104 is configured to form an exterior front panel when the blank 100 is folded into the box 200. The second panel 104 is foldably connected along one side to the first panel 102, and foldably connected along an other side to the third panel 106. The second panel 104 has a first bottom major flap 130 foldably coupled thereto and a plurality of scalloped, or crescent shaped cut outs 132 along a top edge.

The third panel 106 is another side panel and has a second top minor flap 134 and a second bottom minor flap 136 foldably coupled thereto. The third panel 106 is foldably connected along one side to the second panel 104, and foldably connected along an other side to the fourth panel 108.

The fourth panel 108 forms a first rear panel of the box 200 when the blank 100 is folded. The fourth panel has a second, bottom, major flap 138 foldably coupled thereto, and a plurality of first, top major flaps 140 foldably coupled thereto.

The fifth panel 110 forms an interior side panel when the blank 100 is folded into the box 200. The interior surface of the first panel 102 is configured to adhesively couple to an exterior surface of the fifth panel 110 via one or more adhesive or glue strips 111.

The sixth panel 112 forms an interior front panel when the blank 100 is folded into the box 200. The sixth panel 112 has a plurality of folding dispensing flaps 142 removably coupled thereto. Each flap 142 has at least one opening 144 therein, and a portion of each flap 142 forms one of a plurality of second, top major flaps 145. When the blank 100 is folded into the box 200, the openings 144 align with the cutouts 132 so that then the flaps 142 are lifted, the openings 144 are exposed, and the contents of the chambers can be dispensed therethrough. The sixth panel 112 is foldably connected along one side to the fifth panel 110, and foldably connected along an other side to the seventh panel 114.

The seventh panel 114 forms an interior side panel of the box 200 when the blank 100 is folded, positioned up against an interior surface of the third panel 106. Optionally, the exterior surface of the seventh panel 114 is adhesively coupled to the interior surface of the third panel 106. The seventh panel 114 is foldably connected along one side to the sixth panel 112, and foldably connected along an other side to the eighth panel 116.

The eighth panel 116 forms an interior rear surface of the first compartment when the blank 100 is folded into the box 200. The eighth panel 116 is folded to lie up against the fourth panel 108. The first compartment is formed by a portion sixth panel 112 (forming an interior front surface of the chamber), the eighth panel 116 forming the rear wall, the seventh panel 114 forming a first side wall of the chamber, and the ninth panel 118 forming a second side wall of the chamber. The eighth panel 116 is foldably connected along one side to the seventh panel 114, and foldably connected along an other side to the ninth panel 118. Optionally, the interior surface of the eighth panel 116 comprises one or more adhesive/glue strips 117 thereon.

The ninth panel 118 forms a side wall of the first chamber and a side wall of the second chamber, when the blank 100 is folded into the box 200. The ninth panel 118 is foldably connected along one side to the eighth panel 116, and foldably connected along an other side to the tenth panel 120.

The tenth panel 120 forms an interior front panel of the second chamber, wherein an exterior surface of the tenth panel 120 is configured to adhesively couple to an interior surface of the sixth panel 112 via one or more glue/adhesive strips 121. The tenth panel 120 has an opening 146 therein, wherein a loop 148 is formed. The loop 148 forms an internal structure that prevents spillage of the middle chambers contents into the outer chamber contents when the middle flap 142 is lifted open. The tenth panel 120 is foldably connected along one side to the ninth panel 118, and foldably connected along an other side to the eleventh panel 122.

The eleventh panel 122 forms a shared side wall between the second compartment and the third compartment when the blank 100 is folded into the box 200. The eleventh panel 122 is foldably connected along one side to the tenth panel 120, and foldably connected along an other side to the twelfth panel 124.

The twelfth panel 124 is configured to have its interior surface adhesively couple to the interior surface of the fourth panel 108 via one or more adhesive and/or glue strops 125.

The order of folding the panels will now be discussed. The blank 100 is oriented as shown in FIG. 1, with its inside surface facing up. First, as shown in FIG. 3, the seventh through twelfth panels 114, 116, 118, 120, 122, 124 are lifted and folded inwards, towards the inside surface of the sixth panel 112. The interior surface of tenth panel 120 is adhesively coupled to the interior surface of the sixth panel 112 via adhesive patch 121. This forms a preliminary structure of the first chamber 123A. This completed second step is shown in more detail in FIGS. 5 and 6, wherein both a bottom view (FIG. 5) and a top view (FIG. 6) are shown.

Referring now to FIG. 4, the second step in folding the blank 100 is shown. Once the interior surface of tenth panel 120 is adhesively coupled to the interior surface of the sixth panel 112, the sixth through twelfth panels 112, 114, 116, 118, 120, 122, 124 and lifted and folded inwards again, until the exterior surface of the eighth panel 116 is proximate the interior surface of the fourth panel 108.

Referring now to FIG. 7, the exterior surface of the twelfth panel 124 and the exterior surface of the eighth panel 116 are adhesively coupled to the interior surface of the fourth panel 108. Now, the preliminary structure of the all three chambers A, B, C is formed.

Referring now to FIGS. 8 and 9, the fourth through twelfth panels 108, 110, 112, 114, 116, 118, 120, 122, 124 are again lifted and folded inward until the exterior surface of the seventh panel 114 is proximate the interior surface of the third panel 106, and the exterior surface of the sixth panel 112 is proximate the interior surface of the second panel 104. The exterior surface of the seventh panel 114 is then adhesively coupled the interior surface of the third panel 106.

Referring now to FIG. 10, the first panel 102 is folded up, and its interior surface is adhesively coupled to the exterior surface of the fifth panel 110.

Referring now to FIGS. 11, 12 and 13, the basic form of the box 200 is shown, wherein all sides panels are formed/completed and the bottom and top portions of the box remain open. The bottom of the box 200 is sealed by first folding the bottom, minor panels 128, 136 inwards (FIG. 11), and then folding the bottom major panels 130, 138 inwards, over the minor panels 128, 136 (FIG. 12), and adhesively coupling the major panels 130, 138 to each other to seal the bottom of the box 200 (FIG. 13).

Referring now to FIGS. 14 and 15, top and bottom plan views are shown of the partially folded box 200. Now the box 200 can be filled through its open top, as shown in FIG. 16.

Referring now to FIGS. 17, 18 and 19, once the box 200 is filled, the top of the box 200 is sealed by first folding the top, minor tabs 126, 134 inwards, and also folding the loop 148 to bend and fold inwards as well. This is shown in FIG. 17.

Next, in FIG. 18, the plurality of first major tabs 140 are folded inwards, over the folded minor tabs 126, 134 and loop 148.

Referring now to FIG. 19, next, the second major tabs 145 folded over the folded first major tabs 140, and an interior surface of the second major tabs 145 are adhesively coupled to an outside surface of the first major tabs 140, sealing the box 200. The completed top of the box 200 is shown in FIG. 20.

Referring now to FIGS. 20 and 21, when the consumer receives the box 200, the box 200 is in its sealed position from the manufacturer. In order for the consumer to gain access to the contents of the box, the user must break the perforation 150 that couples the front insertion flaps 145 to the sixth panel 112, and lift the flap 145. This is shown in FIG. 21.

Tabs 152 and 154 align (this can be easily seen in FIG. 20), creating an easy lifting point for the consumer to utilize.

When the consumer has finished dispensing, the flap 145 can be slide downwards and into the closed position, closing off dispensing opening 144 so that the contents of the box 200 cannot leave the box 200.

The blank 100 and therefore box 200 can be made from any standard material used for making boxes, such as paperboard, cardboard, corrugated materials, etc. The blank 100 and therefore box 200 can be any dimensions necessary to accommodate different sized products therein.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference.

What is claimed is:

1) A blank for forming a three-chambered box, the blank comprising:
a) a first panel having:
i) a first side;
ii) a second side;
iii) a first top minor flap foldably coupled to a top edge of the first panel; and
iv) a first bottom minor flap foldably coupled to a bottom edge of the first panel;
b) a second panel having:
i) a first side, wherein the first side of the second panel is foldably coupled to the second side of the first panel;
ii) a second side;
iii) a first bottom major flap foldably coupled to a bottom edge of the second panel; and
iv) a top edge of second panel comprising at least one crescent shaped portion;
c) a third panel having:
i) a first side, wherein the first side of the third panel is foldably coupled to the second side of the second panel;
ii) a second side;
iii) a second top minor flap foldably coupled to a top edge of the third panel; and
iv) a second bottom minor flap foldably coupled to a bottom edge of the third panel;
d) a fourth panel having:
i) a first side, wherein the first side of the fourth panel is foldably coupled to the second side of the third panel;
ii) a second side;
iii) a second bottom major flap foldably coupled to a bottom edge of the fourth panel; and
iv) at least one first top major flap foldably coupled to a top edge portion of the fourth panel, each first top major flap having at least one tab;
e) a fifth panel having:
i) a first side, wherein the first side of the fifth panel is foldably coupled to the second side of the fourth panel; and
ii) a second side;
f) a sixth panel having:
i) a first side, wherein the first side of the sixth panel is foldably coupled to the second side of the fifth panel;
ii) a second side; and
iii) at least one dispensing flap removably coupled to a top edge of the sixth panel, wherein each dispensing flap has:
(1) at least one opening therethrough; and
(2) at least one dispensing flap tab;
g) a seventh panel having:
i) a first side, wherein the first side of the seventh panel is foldably coupled to the second side of the sixth panel; and
ii) a second side;
h) an eighth panel having:
i) a first side, wherein the first side of the eighth panel is foldably coupled to the second side of the seventh panel; and
ii) a second side;
b) a ninth panel having:
i) a first side, wherein the first side of the ninth panel is foldably coupled to the second side of the eighth panel; and
ii) a second side;
c) a tenth panel having:
i) a first side, wherein the first side of the tenth panel is foldably coupled to the second side of the ninth panel;
ii) a second side; and
iii) at least one opening in the tenth panel, wherein at least one loop is formed along a distal end of the tenth panel;
d) an eleventh panel having:
i) a first side, wherein the first side of the eleventh panel is foldably coupled to the second side of the tenth panel; and
ii) a second side;
e) a twelfth panel having:
i) a first side, wherein the first side of the twelfth panel is foldably coupled to the second side of the eleventh panel; and
ii) a second side.

2) The blank of claim 1, wherein the blank is made from paperboard.

3) A three-chambered box formed from the blank of claim 1.

4) A blank for forming a three-chambered box, the blank comprising:
a) a first panel;
b) a second panel;
c) a third panel;
d) a fourth panel having:
i) a first side;
ii) a second side;
iii) a second bottom major flap foldably coupled to a bottom edge of the fourth panel; and
iv) at least one first top major flap foldably coupled to a top edge portion of the fourth panel, each first top major flap having at least one tab;
e) a fifth panel;
f) a sixth panel having:
i) a first side, wherein the first side of the sixth panel is foldably coupled to the fifth panel;
ii) a second side; and
iii) at least one dispensing flap removably coupled to a top edge of the sixth panel;
g) a seventh panel;
h) an eighth panel;
i) a ninth panel;
j) a tenth panel having:
i) a first side, wherein the first side of the tenth panel is foldably coupled to the ninth panel;
ii) a second side; and
iii) at least one opening in the tenth panel, wherein at least one loop is formed along a distal end of the tenth panel;
k) an eleventh panel; and
l) a twelfth panel.

5) The blank of claim 4, wherein the first panel has:
a) a first side;
b) a second side;
c) a first top minor flap foldably coupled to a top edge of the first panel; and
d) a first bottom minor flap foldably coupled to a bottom edge of the first panel.

6) The blank of claim 4, wherein the second panel has:
a) a first side, wherein the first side of the second panel is foldably coupled to the first panel;
b) a second side;
c) a first bottom major flap foldably coupled to a bottom edge of the second panel; and
d) a top edge of second panel comprising at least one crescent shaped portion.

7) The blank of claim 4, wherein the third panel has:
a) a first side, wherein the first side of the third panel is foldably coupled to the second panel;
b) a second side;
c) a second top minor flap foldably coupled to a top edge of the third panel; and
d) a second bottom minor flap foldably coupled to a bottom edge of the third panel.

8) The blank of claim 4, wherein the fifth panel has:
a) a first side, wherein the first side of the fifth panel is foldably coupled to the fourth panel; and
b) a second side.

9) The blank of claim 4, wherein the at least one dispensing flap has:
a) at least one opening therethrough; and
b) at least one dispensing flap tab.

10) The blank of claim 4, wherein the seventh panel has:
a) a first side, wherein the first side of the seventh panel is foldably coupled to the sixth panel; and
b) a second side.

11) The blank of claim 4, wherein the eighth panel has:
a) a first side, wherein the first side of the eighth panel is foldably coupled to the seventh panel; and
b) a second side.

12) The blank of claim 4, wherein the ninth panel has:
a) a first side, wherein the first side of the ninth panel is foldably coupled to the eighth panel; and
b) a second side.

13) The blank of claim 4, wherein the eleventh panel has:
a) a first side, wherein the first side of the eleventh panel is foldably coupled to the tenth panel; and
b) a second side.

14) The blank of claim 4, wherein the twelfth panel has:
a) a first side, wherein the first side of the twelfth panel is foldably coupled to the eleventh panel; and
b) a second side.

15) The blank of claim 4, wherein the blank is made from paperboard.

16) A three-chambered box formed from the blank of claim 4.

17) A blank for forming a three-chambered box, the blank comprising:
a) twelve longitudinally connected panels wherein:
i) a fourth panel has:
(1) a first side;
(2) a second side;
(3) a second bottom major flap foldably coupled to a bottom edge of the fourth panel; and
(4) at least one first top major flap foldably coupled to a top edge portion of the fourth panel, each first top major flap having at least one tab;
ii) a sixth panel has:
(1) a first side, wherein the first side of the sixth panel is foldably coupled to a fifth panel;
(2) a second side; and
(3) at least one dispensing flap removably coupled to a top edge of the sixth panel; and
iii) a tenth panel has:
(1) a first side, wherein the first side of the tenth panel is foldably coupled to a ninth panel;
(2) a second side; and
(3) at least one opening in the tenth panel, wherein at least one loop is formed along a distal end of the tenth panel.

18) The blank of claim 17, wherein the blank is made from paperboard.

19) A three-chambered box formed from the blank of claim 17.

20) A method of folding a blank to form a three-chambered box, the method comprising the steps of:
a) providing the blank of claim 1;
b) lifting and folding the seventh, eighth, ninth, tenth, eleventh and twelfth panels inwards, toward an interior surface of the sixth panel;
c) coupling an interior surface of the tenth panel to the interior surface of the sixth panel;
d) lifting and folding the sixth, seventh, eighth, ninth, tenth, eleventh and twelfth panels inwards until an exterior surface of the eighth panel is proximate an interior surface of the fourth panel;
e) coupling an exterior surface of the twelfth panel to the interior surface of the fourth panel, and, coupling the exterior surface of the eighth panel to the interior surface of the fourth panel;
f) lifting and folding the fourth, fifth, sixth, seventh, eighth, ninth, tenth, eleventh and twelfth panels inwards until an exterior surface of the seventh panel is proximate an interior surface of the third panel, and, an exterior surface of the sixth panel is proximate an interior surface of the second panel;
g) coupling the exterior surface of the seventh panel to the interior surface of the third panel;
h) folding and coupling an interior surface of the first panel to an exterior surface of the fifth panel;
i) folding the first and second bottom, minor panels inwards;
j) folding the first and second bottom, major panels inwards and coupling an interior surface of the first and second bottom, major panels to an exterior surface of the first and second bottom minor panels;
k) folding the first and second top minor flaps and the loop inwards;
l) folding the first major tabs inwards, overlapping the folded first and second top minor flaps and loop; and
m) folding the second major tabs inwards and coupling an interior surface of the second major tabs to an exterior surface of the first major tabs.
